(19) United States
(12) Patent Application Publication
(10) Pub. No.: US 2014/0104838 A1
(43) Pub. Date: Apr. 17, 2014

(54) LIGHTING APPARATUS PRODUCTION

(71) Applicant: OSRAM GmbH, Muenchen (DE)

(72) Inventors: Martin Reiss, Sinzing (DE); Gerhard Holzapfel, Rain (DE)

(73) Assignee: OSRAM GmbH, Muenchen (DE)

(21) Appl. No.: 14/054,846

(22) Filed: Oct. 16, 2013

(30) Foreign Application Priority Data
Oct. 16, 2012 (DE) 102012218786.3

(51) Int. Cl. F21K 99/00

(52) U.S. Cl. CPC F21K 9/90; F21K 9/00
USPC 362/249.06; 156/307.1; 156/272.2

(57) ABSTRACT

In various embodiments, a method for producing a lighting apparatus is provided. The method may include providing a light strip with a strip-shaped carrier and a plurality of semiconductor light sources arranged in a row on the carrier; attaching at least one preshaped wall to the carrier, which wall, when attached to the carrier, consists of a curable but not yet completely cured material; filling regions above the carrier next to the at least one wall with at least one curable filler; and curing at least the filler.

### CROSS-REFERENCE TO RELATED APPLICATION

This application claims priority to German Patent Application Serial No. 10 2012 218 786.3, which was filed Oct. 16, 2012, and is incorporated herein by reference in its entirety.

### TECHNICAL FIELD

Various embodiments relate generally to a method for producing a lighting apparatus, including providing a light strip with a strip-shaped carrier and a plurality of semiconductor light sources arranged in a row on the carrier. In addition, various embodiments relate to a lighting apparatus produced in this way. Various embodiments may be applied e.g. to LED strips, e.g. deformable LED strips.

### BACKGROUND

It is known to design simple LED strips in the form of a strip-shaped printed circuit board on a base of a U profile, which printed circuit board is populated on one side with light-emitting diodes (LEDs) and subsequently to cast said LED strips with a light-transmissive casting compound. However, such a production is material-intensive and results in a lighting apparatus having a large volume in comparison with the original LED strip. In addition, a variation of the shape of the lighting apparatus is only possible as a result of a reconfiguration of the U profile, which is complicated and makes storage more difficult for quick and inexpensive production.

### SUMMARY

In various embodiments, a method for producing a lighting apparatus is provided. The method may include providing a light strip with a strip-shaped carrier and a plurality of semiconductor light sources arranged in a row on the carrier; attaching at least one preshaped wall to the carrier, which wall, when attached to the carrier, consists of a curable but not yet completely cured material; filling regions above the carrier next to the at least one wall with at least one curable filler; and curing at least the filler.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a sectional illustration in a side view of a light strip and a wall to be attached to the upper side thereof for producing a lighting apparatus in accordance with a first embodiment;

FIG. 2 shows a sectional illustration in a side view of the light strip with the wall attached to the upper side thereof;

FIG. 3 shows a sectional illustration in a side view of a finished lighting apparatus in accordance with the first embodiment;

FIG. 4 shows, in plan view, a detail of the light strip from FIG. 1 to FIG. 3;

FIG. 5 shows, in plan view, the wall from FIG. 1 to FIG. 3;

FIG. 6 shows, in plan view, the light strip with the wall attached to the upper side thereof;

FIG. 7 shows, in plan view, the finished lighting apparatus in accordance with the first embodiment;

FIG. 8 shows a sectional illustration in a side view of a wall in accordance with a further embodiment;

FIG. 9 shows a sectional illustration in a side view of a wall in accordance with yet another embodiment;

FIG. 10 shows a sectional illustration in a side view of a finished lighting apparatus in accordance with a second embodiment;

FIG. 11 shows a sectional illustration in a side view of a light strip and two walls to be attached to the upper side thereof for producing a lighting apparatus in accordance with a third embodiment;

FIG. 12 shows a sectional illustration in a side view of the light strip with the wall attached to the upper side thereof from FIG. 11;

FIG. 13 shows a sectional illustration in a side view of a finished lighting apparatus in accordance with the third embodiment;

FIG. 14 shows a plan view of the light strip shown in FIG. 11 to FIG. 13;

FIG. 15, in plan view, the walls shown in FIG. 11 to FIG. 13;

FIG. 16 shows, in plan view, the light strip with the wall fitted to the upper side thereof;

FIG. 17 shows, in plan view, the finished lighting apparatus in accordance with the third embodiment;

FIG. 18 shows a sectional illustration in a side view of a finished lighting apparatus in accordance with a fourth embodiment.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments may at least partially overcome the disadvantages of the prior art.

Various embodiments provide a method for producing a lighting apparatus, having at least the following: providing a light strip with a strip-shaped carrier and a plurality of semiconductor light sources arranged in a row on the carrier; attaching at least one preshaped wall to the carrier, which wall, when it is attached to the carrier, consists of a curable but not yet completely cured material; filling regions above the carrier next to the at least one wall with at least one curable filler; and curing at least the filler.

This method provides a compact strip-shaped lighting apparatus in a simple manner. It is also thus possible for the materials used for the production to be used particularly effectively. Furthermore, a variation of the lighting apparatus is possible in a simple manner and with a large breadth of variation.

The lighting apparatus is therefore likewise strip-shaped. The lighting apparatus may be deformable or bendable without being destroyed, in various embodiments perpendicularly to a plane of the carrier. For this, in various embodiments the carrier and the at least one wall are deformable. The lighting apparatus may alternatively be non-deformable or rigid. For this, in various embodiments the carrier and/or the at least one wall can be rigid or non-deformable. A deformable material, in various embodiments the wall and/or filler, may be understood to be, in various embodiments a material with a Shore A hardness of less than 70, a non-deformable material corresponding to a material with a hardness (Shore A) of more than 70.

Light strips are commercially available, for example as the flexible light strip of the type “LinearLight Flex” by Osram.

The strip-shaped carrier may be a deformable or a rigid carrier, in various embodiments depending on whether the lighting apparatus is deformable or rigid. The carrier may in various embodiments be a printed circuit board.

The semiconductor light sources may be arranged in various embodiments only on one side of the carrier, which may be referred to as the front side without in any way restricting the generality. Then, the carrier may be attached with its rear side various embodiments flat on a substrate, for example via a double-sided adhesive tape. The substrate can be a strip-shaped plate, which forms part of the lighting apparatus.

In various embodiments, the at least one semiconductor light source includes at least one light-emitting diode. When a plurality of light-emitting diodes are provided, said light-emitting diodes can illuminate in the same color or in different colors. A color may be monochrome (for example red, green, blue, etc.) or multichrome (for example white). The light emitted by the at least one light-emitting diode may also be an infrared light (IR LED) or an ultraviolet light (UV LED). A plurality of light-emitting diodes can produce a mixed light, for example a white mixed light. The at least one light-emitting diode may contain at least one wavelength-modifying phosphor (conversion LED). The phosphor may alternatively or additionally be arranged remotely from the light-emitting diode (“remote phosphor”). The at least one light-emitting diode may be in the form of at least one individually housed light-emitting diode or in the form of at least one LED chip. A plurality of LED chips may be mounted on a common substrate (“submount”). The at least one light-emitting diode may be equipped with at least one dedicated and/or common optical element for beam guidance, for example at least one Fresnel lens, collimator or the like. Instead of or in addition to inorganic light-emitting diodes, for example based on InGaN or AlInGaP, organic LEDs (OLEDs, for example polymer OLEDs) can generally also be used. Alternatively, the at least one semiconductor light source can have at least one diode laser, for example.

A preshaped wall or top layer may be understood in various embodiments to mean a body which has been produced separately with the correct shape prior to being attached and therefore does not take its shape only when it is attached to the carrier. In a state in which it is positioned on the carrier, the body may in various embodiments be (continuously) higher than the semiconductor light sources, with the result that it can act as a wall of a casting mold for later filling with filler.

The preshaped wall may in various embodiments have been produced by means of an extrusion method and possibly subsequent cutting and/or stamping. This development enables various embodiments quick production of the at least one wall and virtually continuous production.

Owing to the fact that the material of the at least one wall is curable, but is not yet completely cured, it is sufficiently deformable for being positioned onto the carrier and can thus additionally be cohesively connected to the carrier. A later solid form may be produced after curing.

The material of at least one wall may be a base material with or without (an) additive(s). The material of the filler may also be a base material with or without (an) additive(s). The base material of the at least one wall and the material of the filler can be identical or different in respect of the base material and/or the at least one additive, for example with respect to the presence, nature and/or concentration thereof.

One development consists in that the base material includes or is a thermoplastic polymer, silicone, polyurethane (PU or PUR) or epoxy resin. Such a base material is, in terms of its optical properties, multiply variable, curable, easy to handle and inexpensive. The base material is in various embodiments transparent.

A further development consists in that at least one additive is a diffusely scattering additive, for example particles of titanium oxide or a powder thereof. This firstly enables a diffuse light emission from the lighting apparatus and secondly prevents a direct view onto a region covered thereby of the carrier.

Another development consists in that at least one additive is a diffusely scattering additive or a dye, which colors the light emitted by the lighting apparatus (for example red, green, blue, yellow, etc.), for example particles of dye pigment or a powder thereof. This enables a variation of the spectral distribution of the light emission pattern of the lighting apparatus.

An additional development consists in that at least one additive is a wavelength-modifying additive (phosphor or conversion phosphor), which converts the light emitted by a semiconductor light source at least partially into light with a different spectral distribution, in various embodiments a longer wavelength. This enables further variation in the spectral distribution of the light emission pattern and the lighting apparatus. The wavelength-modifying additive may at the same time also act diffusely and/or be colored.

Filling regions above the carrier next to the at least one wall also includes filling regions above the semiconductor light sources. The filling may include, in various embodiments, casting, wherein the filler then has at least one casting compound.

The filling may include complete or partial filling of the region.

A single filler may be used for the filling, or it is possible for a plurality of fillers to be used, with the result that a layer structure is produced. For example, the semiconductor light sources can first be covered with a transparent filler (so that they are embedded therein) and then a non-transparent (for example diffuse, colored and/or wavelength-modifying) filler may be applied to this transparent filler. This development provides the possibility of a particularly high luminous efficacy since back-reflection of light from the diffuse layer is reduced. Thus, an emission angle may also be widened.

The curing of at least the filler may include curing only of the filler if, for example, the at least one wall is already (completely) cured, or can include curing of the filler and the wall. The curing may include exposure to an environment suitable for curing, for example air, heating and/or irradiation with suitable radiation, for example ultraviolet (UV) radiation, etc.

The wall may consist continuously of the same material or may include, for example, also locally different additives or locally alternately additives and no additives.

One configuration consists in that the material of the wall is a material which is curable in air. The material of the wall may in various embodiments begin to cure e.g. shortly before, during or after shaping of the wall, and is not yet completely cured when it is attached to the carrier. This configuration has the advantage that a particularly wide variety of materials can be used without additional additives which first activate curing. This configuration can also be particularly inexpensive.

Yet a further configuration consists in that the material of the wall is an air-curable or UV-curable material. The UV curability may be achieved in various embodiments by means of a UV-activatable filler of the material of the wall in question, which additive accelerates the curing of the base material after activation. However, in addition or as an alternative the base material may also be directly UV-curable, i.e. can begin to cure practically only by UV irradiation. The UV curability enables greater flexibility during production of the lighting apparatus, in various embodiments a longer shelf life of the wall in question and a longer lasting production sequence.

Another configuration consists in that the at least one preshaped wall is band-shaped or strip-shaped and has cutouts for the semiconductor light sources, and the filling includes filling of the cutouts.

A wall with this configuration may be positioned particularly easily on the carrier and requires particularly small amounts of filler. The cutouts or recesses in various embodiments represent a filling mold, e.g. a casting mold, for the at least one filler.

The shape of the cutouts is as desired and may be, for example, round or angular, for example square, in plan view.

A development consists in that this wall (including the cutouts therein) covers the carrier completely. Thus, particularly complete protection of the carrier can be achieved, for example with respect to mechanical and/or chemical loading.

Yet a further configuration consists in that the at least one preshaped wall has two strip-shaped walls, which run in the direction of extent of the carrier peripherally with respect to the semiconductor light sources, and the filling includes filling of an open region between the two walls. This enables a particularly versatile embodiment of the lighting apparatus in a simple manner. For example, a configuration which is laterally asymmetrical with respect to a longitudinal extent can be achieved. For this, the walls can have a different shape and/or composition, for example.

In various embodiments, a free band of the carrier which extends in the longitudinal extent can be produced between the two lateral walls, with the semiconductor light sources also being located on said band. By virtue of the at least one filler, this free band may be at least partially filled.

An additional configuration consists in that the material of the two walls is different. As a result, a light distribution which is laterally asymmetrical with respect to the longitudinal axis or longitudinal extent is enabled in a manner which is simple and is easily doable using manufacturing technology.

One development, e.g. for the case where the material of the two walls is different, consists in that at least some of the semiconductor light sources are laterally emitting semiconductor light sources, for example so-called side LEDs. A laterally emitting semiconductor light source may be understood in various embodiments to mean a semiconductor light source whose main emission direction (at which the greatest radiation intensity occurs) does not occur perpendicularly to a resting plane of the semiconductor light source, but at an angle thereto. Since the resting plane usually also corresponds to the plane of a carrier, this can in various embodiments also be understood to mean that a main emission direction of a laterally emitting semiconductor light source is not perpendicular to the surface of the carrier (on which the semiconductor light source is fastened), but is at an angle thereto. In various embodiments, the laterally emitting semiconductor light source can have a main emission direction parallel to the surface of the carrier.

The use of laterally emitting semiconductor light sources enables comparatively simple reproduction of shapes by corresponding bending of the (deformable) lighting apparatus. In the case of a rigid lighting apparatus, a lighting apparatus which is readily suitable for side emission and can be attached in a particularly compact manner results.

In general, the semiconductor light sources may be laterally emitting semiconductor light sources (for example side LEDs) and/or perpendicularly emitting semiconductor light sources, in the case of which the main emission direction is perpendicular to the surface of the carrier (for example so-called top LEDs).

Another configuration consists in that the semiconductor light sources are laterally emitting semiconductor light sources and are directed onto a wall made of a material which is light-transmissive, in various embodiments transparent. This enables effective light emission through this wall. The other wall, on which radiation is not directly incident, can be, for example, identical or, for example, also opaque.

Another configuration consists in that the material of the two walls has an identical base material. This simplifies production of the light apparatus, for example by virtue of it being possible to use the same machines for producing different walls.

Yet another configuration consists in that the material of at least one wall and the material of the filler are different. This enables yet another variation in the configuration of the lighting apparatus.

A development which supports a fixed connection between the wall and the filler and eliminates a material mismatch consists in that the material of at least one wall and the material of the filler have the same base material. Then, the wall and the filler may differ from one another, for example, by the presence or lack of one or more additives, by the nature of the at least one additive, by the concentration of at least one additive, etc.

For example, the wall may be colored, while the filler is transparent. A different optical property assists in various embodiments “punctiform” optically effective light emission.

However, the material of at least one wall can in principle equate to the material of the filler. Thus, both the wall and the filler may be transparent or have the same color given the same base material.

Yet another configuration consists in that the attachment of the at least one preshaped wall to the carrier comprises a roll lamination, in various embodiments on both sides. This may be advantageous since the wall and the carrier can be brought into adhesive or cohesive connection with one another in a simple manner. Thus a quick marriage between the carrier and at least one wall is also possible, in various embodiments in the context of a “quasi” continuous process, for example a roll-to-roll process.

Various embodiments provide a lighting apparatus which has been produced by means of the abovementioned method. This lighting apparatus has the same advantages as the method and can be configured similarly.

The lighting apparatus can in various embodiments have a light strip with a strip-shaped carrier and a plurality of semiconductor light sources arranged in a row on the carrier and a cover, which is attached to the carrier and has a plurality of regions, wherein a first region of the cover is formed by at least one wall running at least in the longitudinal extent laterally next to the semiconductor light sources, and at least one second region of the cover is formed by at least one filler covering the semiconductor light sources, wherein the lighting apparatus has been produced by means of the method as claimed in one of the preceding claims.

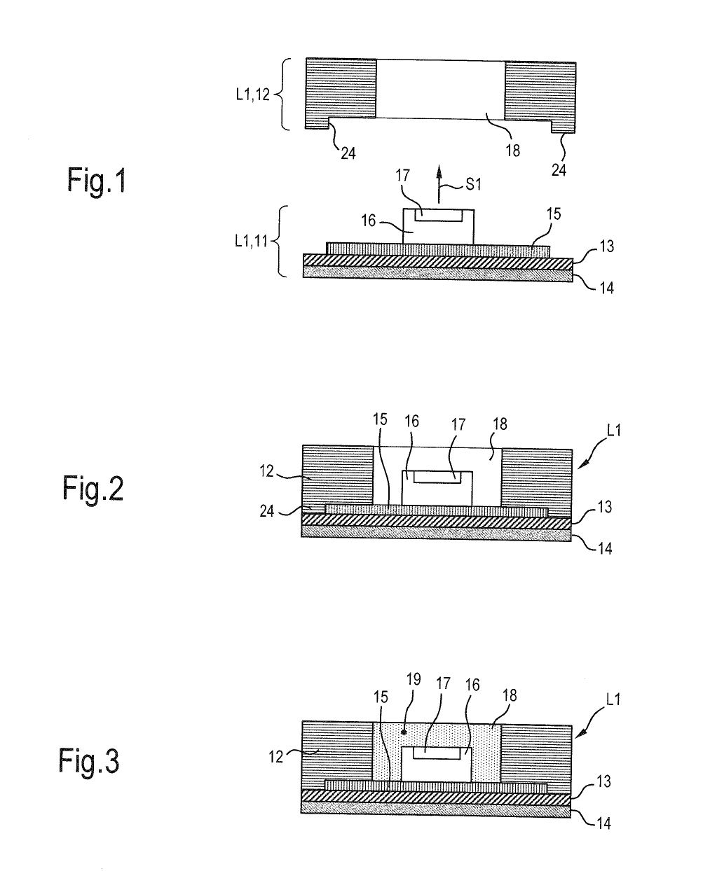

FIG. 1 shows a sectional illustration in a side view of a light strip 11 and a wall 12 to be attached to the upper side thereof for producing a strip-shaped lighting apparatus L1 in accordance with a first embodiment. The wall 12 may also be referred to as a top layer or cover.

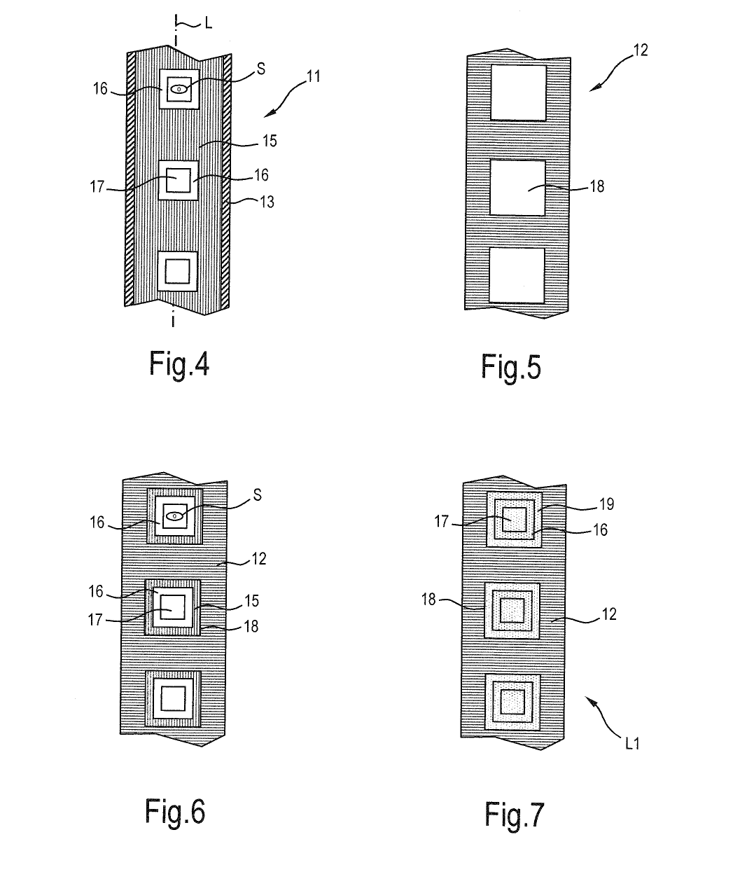

The light strip which is shown in plan view in FIG. 4 has a strip-shaped, in this case, for example, flexible printed circuit board 13 as carrier which is attached with its rear side on a flexible substrate 14. On the front side, the printed circuit board 13, possibly by means of a solder resist 15, is populated with a semiconductor light source in the form of an upwardly emitting LED, namely a so-called top LED 16. As is shown in FIG. 4, a plurality of top LEDs 16 are arranged in a row equidistantly on the printed circuit board 13. The top LEDs 16 have a main emission direction S1, which is perpendicular to the front side of the printed circuit board 13. The top LEDs 16 are in this case surface-emitting LEDs, whose emitter faces 17 are located on the front surface of the top LEDs 16. The light strip 11 is capable of being bent without being destroyed along its longitudinal axis L and perpendicular to a surface of the printed circuit board 13, and it is also intended to be this way.

The wall 12, which is illustrated in plan view in FIG. 5, has a strip-shaped basic shape, whose width corresponds to a width of the light strip 11. The wall 12 comprises a material which is curable but is not yet completely cured in the shown form, for example silicone. The wall 12 has in this case been produced by means of an extrusion process.

Above the top LEDs 16, the wall has recesses or cutouts 18. These are square in plan view, but can in principle have any other closed shape, for example generally rectangular, round, oval or freeform. The cutouts 18 can have been introduced, for example, by being stamped or cut out of an extrudate. Since the wall 18 is higher than the top LEDs 16, the cutouts form corresponding filling molds for the top LEDs 16.

In cross section, the wall 12 has a rectangular, flat basic shape, wherein in each case one projection 24 is provided peripherally on the rear side or lower side, which projection fits into a step produced by the solder resist 15 on the printed circuit board 13. The projection 24 enables surface contact-making even at the lateral rim of the printed circuit board 13 (avoidance of a lateral split) and can furthermore be used for positioning.

In a step following the provision, as shown in FIG. 2 and FIG. 6, the wall 12 and the light strip 11 are married, to be precise by applying or fastening the wall 12 to the upper side of the light strip 11. Since the material of the wall 12 has not yet cured, it adheres to the light strip 11 and produces a cohesive connection. The marriage can be implemented in various embodiments by roll lamination.

Then, as shown in FIG. 3 and FIG. 7, the cutouts 18 are filled with a light-transmissive filler in the form of a curable casting compound 19, for example silicone, by casting so that the top LEDs 16 are embedded completely in the casting compound 19 and in various embodiments also the emitter face 17 of said LEDs is covered by the casting compound 19. Once curing has taken place, for example in air and possibly assisted by a heat treatment and/or irradiation with UV radiation, a deformable lighting apparatus L1 is provided.

The wall 12 and the casting compound 19 may include the same or different material. The respective material may in various embodiments have a light-transmissive, e.g. transparent, basic compound (matrix material) and possibly at least one additive. Suitable additives are, for example, diffuser particles, dyes and/or phosphors, which may be provided individually or in combination. In various embodiments if the wall 12 is light-nontransmissive for the light emitted by the top LEDs 16, the lighting apparatus L1 provides the possibility of spot-like light emission out of the cutouts 18.

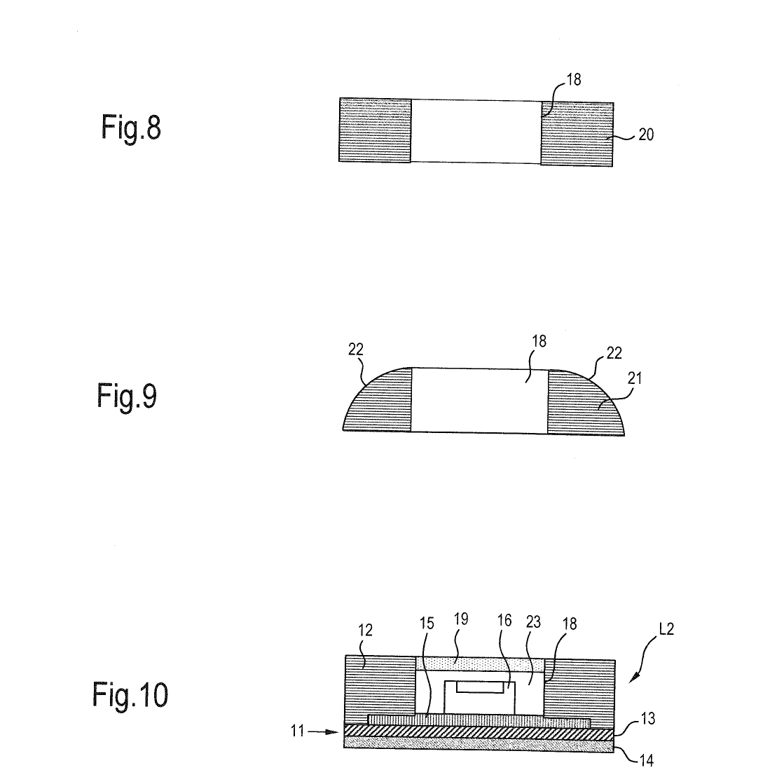

FIG. 8 shows a wall 20, which is formed identically to the wall 12, apart from the fact that there are no longer the projections 24. This enables simpler production and can represent an advantage in various embodiments for the case where no solder resist is present or the solder resist has a negligible height.

FIG. 9 shows a wall 21, which is formed identically to the wall 20 apart from the fact that the side rims 22 are now rounded off. This may save on material in various embodiments and provide a surface with a low mechanical resistance.

FIG. 10 shows a sectional illustration in a side view of a finished lighting apparatus L2 in accordance with a second embodiment. The lighting apparatus L2 has, in the same way as the lighting apparatus L1, the light strip 11 and the wall 12. However, it is now no longer the case that only the one casting compound 19 is provided in the cutout 18, but in addition a casting compound 23 is provided. The casting compound 23 has first been cast into the cutout 18 and covers the top LED 16. The casting compound 19 has been cast onto the casting compound 23, with the result that a two-layered casting compound arrangement is provided in the cutout 18. The two casting compounds have e.g. a different material. Thus, the casting compound 23 may e.g. be transparent, for example by using a transparent base material without additives, and the casting compound can scatter diffusely, for example by virtue of the use of the same transparent base material with diffuser particles as additive. The wall 12 may be light-nontransmissive, for example. The lighting apparatus L2 has the advantage over the lighting apparatus L1 that it enables areally more uniform light emission.

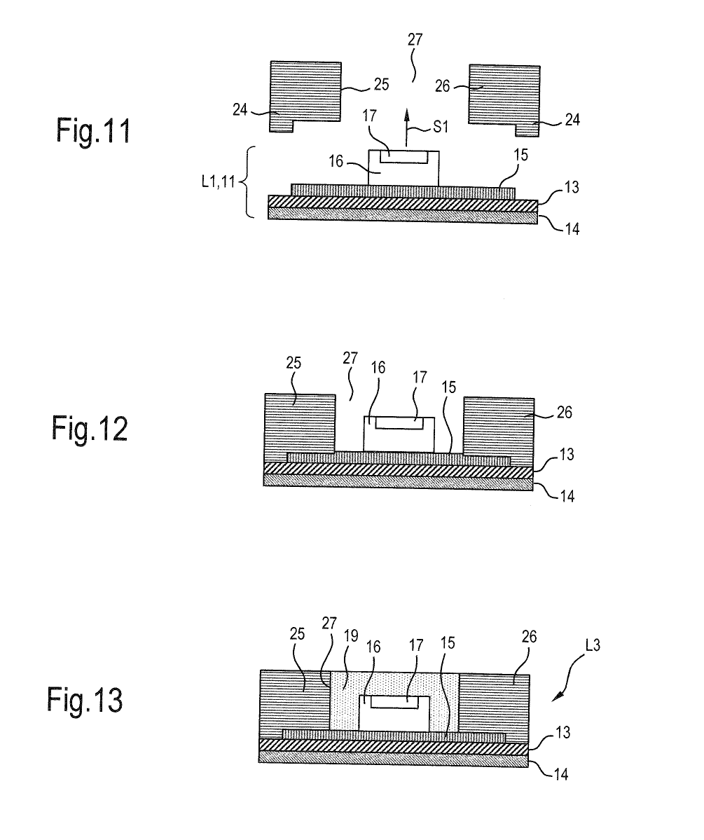

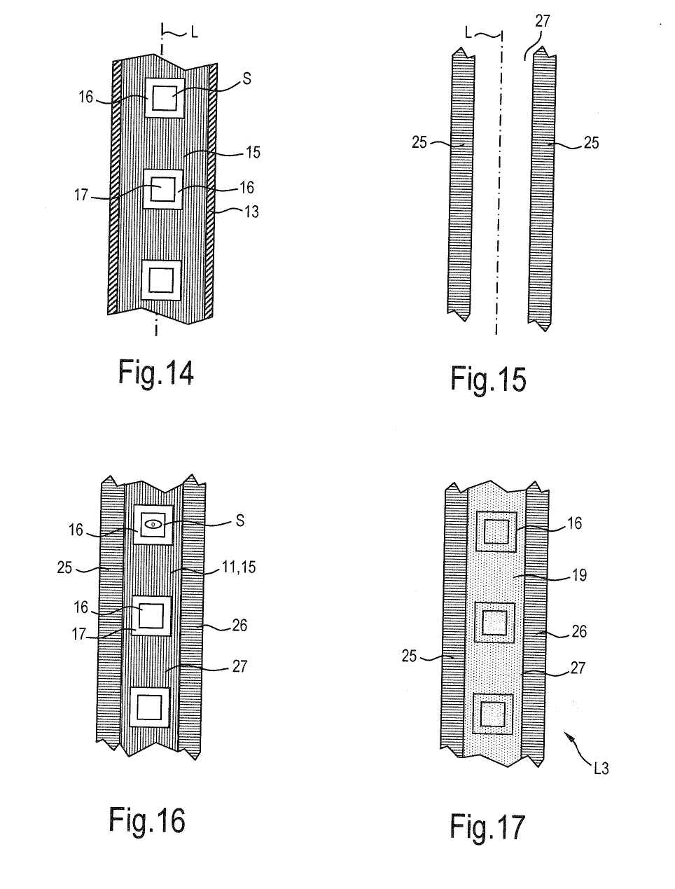

FIG. 11 shows a sectional illustration in a side view of a light strip 11 (as also illustrated in plan view in FIG. 14) and two strip-shaped walls 25, 26 to be attached to the upper side thereof for producing a light strip L3 in accordance with a third embodiment. The wall 25 to be attached here to a left-hand side peripheral region of the light strip 11 and the wall 26 to be attached to a right-hand side peripheral region of the light strip 11 are formed mirror-symmetrically with respect to the longitudinal axis L in plan view, as shown in FIG. 11 and FIG. 15. The walls 25 and 26 each have a projection 24 on their lower side on the outside. The walls 25, 26 can also be produced by means of an extrusion method.

As shown in FIG. 12 and FIG. 16, once the walls 25, 26 have been positioned on the light strip 11 a continuous open region extending in the longitudinal direction L between the two walls 25, 26, namely a free band 27 in which the top LEDs 16 are also located, remains between said walls 25, 26.

As shown in FIG. 13 and FIG. 17, this band 27 is then filled with filler, in this case: cast with the casting compound 19.

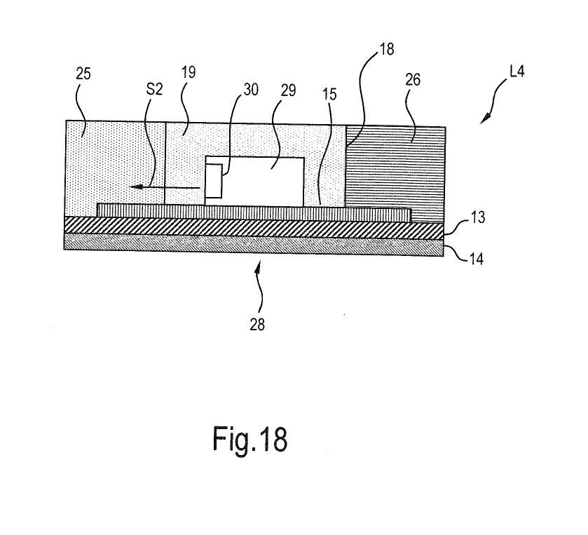

FIG. 18 shows a lighting apparatus L4 in accordance with a fourth embodiment. The lighting apparatus L4 now has a light strip 28, which has a similar design to the light strip 11, but has laterally emitting LEDs, so-called side LEDs 29. The side LEDs 29 have an emitter face 30 on one side, with the result that their main emission direction S2 runs parallel to the surface of the printed circuit board 13. In order to maintain efficient light emission out of the lighting apparatus L4, that wall which is irradiated directly by the side LED 29 (in this case the left-hand wall 25) is light-transmissive (transparent or diffuse). The material of the other wall, in this case the right-hand wall 26, can be the same or different, for example opaque.

If, instead of the casting compound 19 shown, two or more casting compounds 19, 23 are used, for example in a similar manner to the lighting apparatus L2, the casting compound 19 embedding the side LEDs 29 can be light-transmissive and a casting compound 23 positioned thereon can be opaque.

Although the invention has been illustrated and described in detail by the exemplary embodiments shown, the invention is not restricted to these exemplary embodiments and other variations can be derived by a person skilled in the art without departing from the scope of protection of the invention.

Thus, the use of a substrate and/or a solder resist is optional.

It is also possible for various features and elements of the different exemplary embodiments and variations to be combined or used additionally, for example a two-layered casting compound 19, 23 together with two walls 25, 26 which have side rims 22 similar to the wall 21, etc.

In general, “a”, “one” etc. can be understood to mean a singular or plural form, in particular in the sense of “at least one” or “one or more” etc. as long as this is not explicitly ruled out, for example by the expression “precisely one” etc.

Also, an indication of numbers can include precisely the cited number and a conventional tolerance band as long as this is not explicitly ruled out.

List of Reference Symbols

11 Light strip

12 Wall

13 Carrier

14 Flexible substrate

15 Solder resist

16 Top LED

17 Emitter surface

18 Cutout

19 Casting compound

20 Wall

21 Wall

22 Side rim

23 Casting compound

24 Projection

25 Wall

26 Wall

27 Band

28 Light strip

29 Side LED

30 Emitter surface

L Longitudinal axis

L1 Lighting apparatus

L2 Lighting apparatus

L3 Light strip

L4 Lighting apparatus

S1 Main emission direction

S2 Main emission direction

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for producing a lighting apparatus, the method comprising:
providing a light strip with a strip-shaped carrier and a plurality of semiconductor light sources arranged in a row on the carrier;
attaching at least one preshaped wall to the carrier, which wall, when attached to the carrier, consists of a curable but not yet completely cured material;
filling regions above the carrier next to the at least one wall with at least one curable filler; and
curing at least the filler.

2. The method of claim 1,
wherein the material of the wall is an air-curable or a UV-curable material.

3. The method of claim 1,
wherein the at least one preshaped wall is strip-shaped and has cutouts for the semiconductor light sources; and
wherein the filling comprises filling of the cutouts.

4. The method of claim 1,
wherein the at least one preshaped wall has two strip-shaped walls which run peripherally with respect to the semiconductor light sources in the direction of extent of the carrier; and
wherein the filling comprises filling an open region between the two walls.

5. The method of claim 4,
wherein the materials of the two walls are different.

6. The method of claim 5,
wherein the semiconductor light sources are laterally emitting semiconductor light sources and are directed onto a wall made of a material which is light-transmissive, in particular transparent.

7. The method of claim 6,
wherein the semiconductor light sources are laterally emitting semiconductor light sources and are directed onto a wall made of a material which is transparent.

8. The method of claim 5,
wherein the material of the two walls has an identical base material.

9. The method of claim 1,
wherein the material of at least one wall and the material of at least one filler are different.

10. The method of claim 1,
wherein the attachment of the at least one preshaped wall to the carrier comprises a roll lamination.

11. The method of claim 10,
wherein the attachment of the at least one preshaped wall to the carrier comprises a roll lamination on both sides.

12. A lighting apparatus, comprising:
a light strip comprising a strip-shaped carrier and a plurality of semiconductor light sources arranged in a row on the carrier;
a cover applied to the carrier and having a plurality of regions;
wherein a first region of the cover is formed by at least one wall which runs laterally next to the semiconductor light sources at least in the longitudinal extent; and
wherein at least one second region of the cover is formed by at least one filler covering the semiconductor light sources;
wherein the lighting apparatus has been produced by means of a method, comprising:
providing a light strip with a strip-shaped carrier and a plurality of semiconductor light sources arranged in a row on the carrier;
attaching at least one preshaped wall to the carrier, which wall, when attached to the carrier, consists of a curable but not yet completely cured material;
filling regions above the carrier next to the at least one wall with at least one curable filler; and
curing at least the filler.
